(19) United States
(12) Patent Application Publication
(10) Pub. No.: US 2012/0059940 A1
(43) Pub. Date: Mar. 8, 2012

(54) TERMINAL DEVICE AND DATA SYNCHRONIZATION METHOD

(75) Inventor: CHUNG-HUNG LIAO, Tu-Cheng (TW)

(73) Assignee: HON HAI PRECISION INDUSTRY CO., LTD., Tu-Cheng (TW)

(21) Appl. No.: 12/894,154

(22) Filed: Sep. 30, 2010

(30) Foreign Application Priority Data
Sep. 2, 2010 (CN) 201010268038.9

(51) Int. Cl. G06F 15/16

(52) U.S. Cl. 709/227

(57) ABSTRACT

A data synchronization method establishes a communication channel between a terminal device and a cloud server through a network. The terminal device accesses the cloud server through the communication channel, and registers a private data space in a data center of the cloud server. Then the method transmits data of the terminal device to the private data space through the communication channel according to user requirements, to back up the data of the terminal device to the private data space.

### BACKGROUND

1. Technical Field

Embodiments of the present disclosure relate to terminal devices, and more particularly to a terminal device and a data synchronization method of the terminal device.

2. Description of Related Art

Terminal devices, such as, mobile phones, mobile Internet devices (MIDs), personal digital assistants (PDAs), and computers, are widely used in daily life. Many people like to use terminal devices to store important data, such as, files, photos, and directories. However, if the terminal devices is damaged or lost, the information stored in the terminal devices may be lost.

### BRIEF DESCRIPTION OF THE DRAWINGS

FIG. 1 is a schematic diagram of the environment of one embodiment of a terminal device of the present disclosure.

FIG. 2 is a block diagram of one embodiment of the terminal device of FIG. 1.

FIG. 3 is a flowchart of one embodiment of a data synchronization method of the terminal device of the present disclosure.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

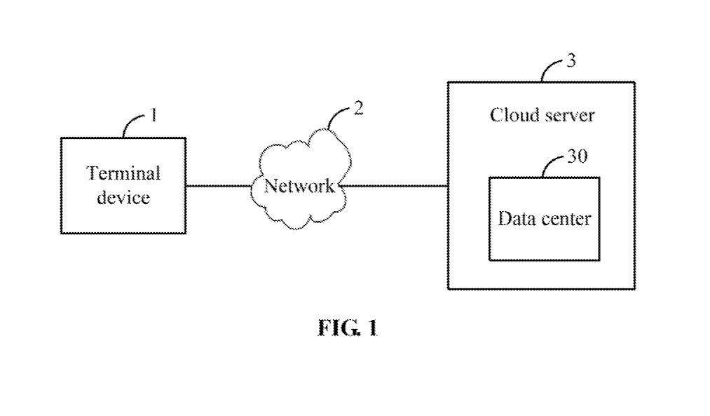

FIG. 1 is a schematic diagram of the environment of one embodiment of a terminal device 1 of the present disclosure. In the embodiment, the terminal device 1 communicates with a cloud server 3 through a network 2. The terminal device 1 may access the cloud server 3 through the network 2, and register a private data space in a data center 30 of the cloud server 3 to back up data of the terminal device 1 to the cloud server 3 and to synchronize the backup data stored in the cloud server 3 with the data of the terminal device 1 when the data of the terminal device 1 is updated. The cloud server 3 may be any kind of server based on cloud computing technology, which may include one or more large-capacity data storages. The terminal device 1 may be, for example, a mobile phone, a personal digital assistant (PDA), a mobile Internet device (MID), or a computer, in which may be installed any operation system, such as WINDOWS or LINUX, for example. The data center 30 may be one of the large-capacity data storages that may used to store data from the terminal device 1, or other devices. The private data space is a storage space in the data center 30 allocated for the terminal device 1 to back up the data from the terminal device 1, such as a storage space of 100 megabytes. The network 2 may be a wireless network or an Internet.

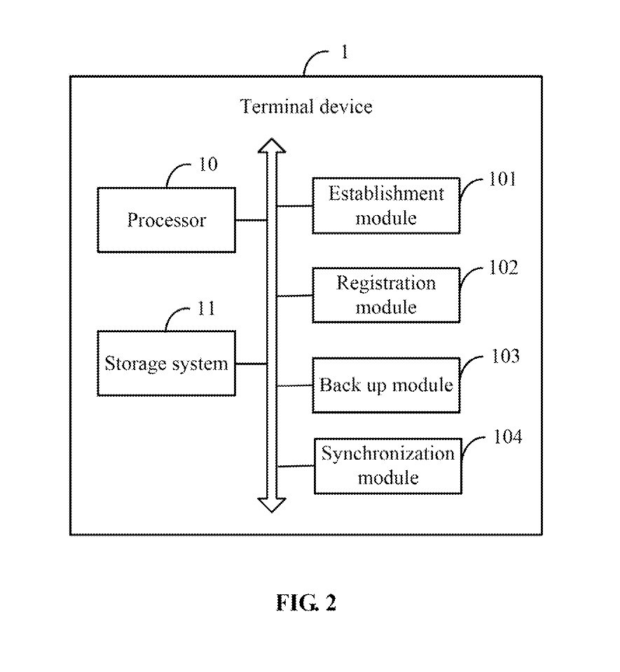

FIG. 2 is a block diagram of one embodiment of the terminal device 1 of FIG. 1. In the embodiment, the terminal device 1 includes a processor 10, a storage system 11, an establishment module 101, a registration module 102, a back up module 103, and a synchronization module 104. The modules 101-104 may comprise computerized code in the form of one or more programs that are stored in the storage system 11. The computerized code includes instructions that are executed by the processor 10 to provide functions for the modules 101-104. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The storage system 11 stores one or more programs of the terminal device 1. In one embodiment, the storage system 11 may be random access memory (RAM) for temporary storage of information, and/or a read only memory (ROM) for permanent storage of information. In other embodiments, the storage system 11 may also be an external storage device, such as a storage card, or a data storage medium. The processor 10 executes computerized operations of the terminal device 1 to provide functions of the terminal device 1.

The establishment module 101 is operable to establish a communication channel between the terminal device 1 and the cloud server 3 through the network 2. When the communication channel is established, the terminal device 1 may transmit data of the terminal device 1 to the cloud server 3 through the communication channel to backup the data of the terminal device 1, and synchronize the backup data of the cloud server 3 with the data of the terminal device 1 when the data of the terminal device 1 is updated. Details of the data back up and synchronization are provided as below.

The registration module 102 accesses the cloud server 3 through the communication channel, and registers a private data space for the terminal device 1 in the data center 30. In one embodiment, the registration module 102 may provide user information (e.g., user name, password, and E-mail) to the cloud server 3 through the network 2 to register the private data space.

The back up module 103 transmits data of the terminal device 1 to the private data space through the communication channel according to user requirements, to back up the data to the private data space. In one embodiment, the back up module 103 may use a hypertext transfer protocol (HTTP) or a simple object access protocol (SOAP) to transmit the data of the terminal device 1 to the private data space. In addition, the back up module 103 may download the backup data of the private data space to the terminal device 1 using the HTTP or the SOAP through the communication channel. For example, when the data of the terminal device 1 is lost or damaged, the back up module 103 may download the data of the private data space to the terminal device 1, to recover the data of the terminal device 1.

The synchronization module 104 detects whether the data of the terminal device 1 has been updated at regular intervals, such as every one day, two days, or three days. In one embodiment, if a directory of the terminal device 1 has been backed up to the private data space, the synchronization module 104 may compare the directory of the terminal device 1 with the directory of the private data space at the regular intervals, to determine whether the directory of the terminal device 1 is synchronized with the directory of the private data space. If the directory of the terminal device 1 is synchronized with the directory of the private data space, the synchronization module 104 determines that the directory of the terminal device 1 has not been updated. Otherwise, if the directory of the terminal device 1 is not synchronized with the directory of the private data space, the synchronization module 104 determines that the directory of the terminal device 1 has been updated.

When the data of the terminal device 1 has been updated, the synchronization module 104 prompts a user to decide whether to synchronize the data of the private data space with data of the terminal device 1. And if the user agrees to synchronize the data of the private data space with data of the terminal device 1, the synchronization module 104 synchronizes the data of the private data space with the data of the terminal device 1, to update the data of the private data space with the updated data of the terminal device 1.

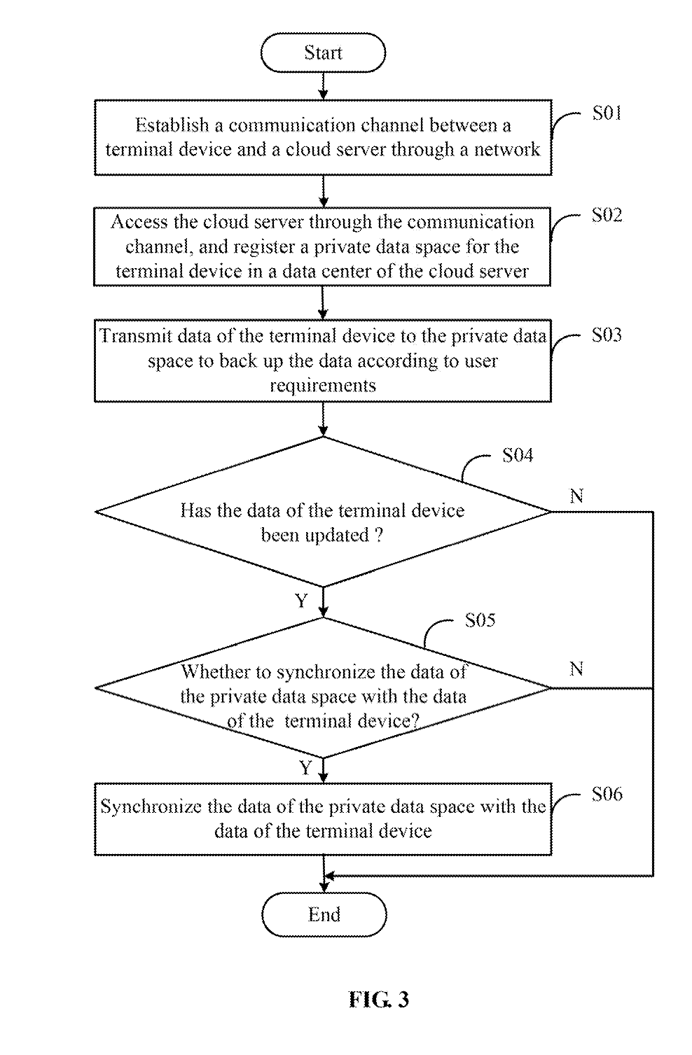

FIG. 3 is a flowchart of a data synchronization method of the terminal device of the present disclosure. Depending on the embodiment, additional blocks may be added, others removed, and the ordering of the blocks may be changed.

In block S01, the establishment module 101 establishes a communication channel between the terminal device 1 and the cloud server 3 through the network 2.

In block S02, the registration module 102 accesses the cloud server 3 through the communication channel, and registers a private data space for the terminal device 1 in the data center 30 of the cloud server 3. In one embodiment, the registration module 102 may provide user information (e.g., user name, password, and E-mail) to the cloud server 3 to register the private data space.

In block S03, the back up module 103 transmits data of the terminal device 1 to the private data space through the communication channel according to user requirements, to back up the data of the terminal device 1 to the private data space. As described above, the back up module 103 may use a hypertext transfer protocol (HTTP) or a simple object access protocol (SOAP) to transmit the data to the private data space.

In block S04, the synchronization module 104 detects whether the data of the terminal device 1 has been updated at regularly intervals, such as every one day, two days, or three days. If the data of the terminal device 1 has been updated, block S05 is implemented. Otherwise, if the data of the terminal device 1 has not been updated, the flow ends.

In block S05, the synchronization module 104 prompts a user to decide whether to synchronize the data of the private data space with the data of the terminal device 1. If the user agrees to synchronize the data of the private data space with the data of the terminal device 1, block S06 is implemented. Otherwise, if the user does not agree to synchronize the data of the private data space with the data of the terminal device 1, the flow ends.

In block S06, the synchronization module 104 synchronizes the data of the private data space with the data of the terminal device 1, to update the data of the private data space with the updated data of the terminal device 1.

When the user wants to download the backup data of the private data space to the terminal device 1, the back up module 103 downloads the backup data of the private data space to the terminal device 1 using the HTTP or the SOAP. For example, when the data of the terminal device 1 is lost or damaged, the back up module 103 may download the backup data of the private data space to the terminal device 1, to recover the data of the terminal device 1.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A terminal device in communication with a cloud server through a network, the terminal device comprising:
a least one processor;
a storage system; and
one or more programs stored in the storage system and executed by the at least one processor, the one or more programs comprising:
an establishment module operable to establish a communication channel between the terminal device and the cloud server through the network;
a registration module operable to access the cloud server through the communication channel, and register a private data space for the terminal device in a data center of the cloud server; and
a back up module operable to transmit data of the terminal device to the private data space through the communication channel, to back up the data of the terminal device to the private data space.

2. The terminal device according to claim 1, further comprising:
a synchronization module operable to detect whether the data of the terminal device has been updated at regularly intervals.

3. The terminal device according to claim 2, wherein the synchronization module further operable to prompt a user to decide whether to synchronize the data of the private data space with the data of the terminal device when the data of the terminal device has been updated, and synchronize the data of the private data space with the data of the terminal device when the user agrees to synchronize the data of the private data space with the data of the terminal device.

4. The terminal device according to claim 1, wherein the back up module further operable to download the backup data of the private data space to the terminal device.

5. The terminal device according to claim 1, wherein the terminal device is a mobile phone, a mobile internet device (MID), a personal digital assistant (PDA), or a computer.

6. A data synchronization method of a terminal device, the terminal device in communication with a cloud server through a network, the method comprising:
establishing a communication channel between the terminal device and the cloud server through the network;
accessing the cloud server through the communication channel, and registering a private data space for the terminal device in a data center of the cloud server; and
transmitting data of the terminal device to the private data space through the communication channel, to back up the data of the terminal device to the private data space.

7. The method according to claim 6, further comprising:
detecting whether the data of the terminal device has been updated at regularly intervals.

8. The method according to claim 7, further comprising:
prompting a user to decide whether to synchronize the data of the private data space with the data of the terminal device when the data of the terminal device has been updated; and
synchronizing the data of the private data space with the data of the terminal device when the user agrees to synchronize the data of the private data space with the data of the terminal device.

9. The method according to claim 6, further comprising:
downloading the backup data of the private data space to the terminal device.

10. The method according to claim 6, wherein the terminal device is a mobile phone, a mobile internet device (MID), a personal digital assistant (PDA), or a computer.

11. A storage medium storing a set of instructions, the set of instructions capable of being executed by a processor of a terminal device, causing the terminal device to perform a data synchronization method, the method comprising:
establishing a communication channel between the terminal device and a cloud server through a network;
accessing the cloud server through the communication channel, and registering a private data space for the terminal device in a data center of the cloud server; and
transmitting data of the terminal device to the private data space through the communication channel, to back up the data of the terminal device to the private data space.

12. The storage medium as claimed in claim 11, wherein the method further comprises:
detecting whether the data of the terminal device has been updated at regularly intervals.

13. The storage medium as claimed in claim 12, wherein the method further comprises:
prompting a user to decide whether to synchronize the data of the private data space with the data of the terminal device when the data of the terminal device has been updated; and
synchronizing the data of the private data space with the data of the terminal device when the user agrees to synchronize the data of the private data space with the data of the terminal device.

14. The storage medium as claimed in claim 11, wherein the method further comprises:
downloading the backup data of the private data space to the terminal device.

15. The storage medium as claimed in claim 11, wherein the terminal device is a mobile phone, a mobile internet device (MID), a personal digital assistant (PDA), or a computer.
